(19) United States
(12) Patent Application Publication
(10) Pub. No.: US 2015/0234583 A1
(43) Pub. Date: Aug. 20, 2015

(54) SYSTEM AND METHOD FOR DIRECT COMMUNICATION BETWEEN A PUBLISHER AND USERS

(71) Applicant: Doat Media Ltd., Tel Aviv (IL)

(72) Inventors: Joey Joseph Simhon, Ramat-Gan (IL); Avi CHARKAM, Givataim (IL); Noam YASOUR, Tel Aviv (IL)

(73) Assignee: DOAT MEDIA LTD., Tel Aviv (IL)

(21) Appl. No.: 14/618,688

(22) Filed: Feb. 10, 2015

Related U.S. Application Data
(63) Continuation-in-part of application No. 14/556,672, filed on Dec. 1, 2014.
Application No. 14/556,672 is a continuation-in-part of application No. 14/580,684, filed on Dec. 23, 2014.
(60) Provisional application No. 61/941,524, filed on Feb. 19, 2014.

(51) Int. Cl. G06F 3/0484; G06F 17/30

(52) U.S. Cl. CPC G06F 3/04847; G06F 3/04842; G06F 17/30905

(57) ABSTRACT

A system and method for generating a direct communication link between a publisher and a user device are presented. The method includes receiving, from a user device, a request to generate at least one entity-based widget on a display of the user device, wherein the request comprises a selection of an entity; finding a contextual content related to the entity through at least one web source operated by at least one publisher server; determining a type of the entity based on the contextual content; generating the at least one entity-based widget based on the contextual content and the type; receiving at least one content item from the at least one publisher server; adapting a display segment within the at least one widget based on the at least one received content item; and displaying the adapted display segment on the user device.

### CROSS-REFERENCE TO RELATED APPLICATIONS

This application claims the benefit of U.S. Provisional Application No. 61/941,524 filed on Feb. 19, 2014. This application is also a continuation-in-part (CIP) of:

1) U.S. patent application Ser. No. 14/556,672 filed on Dec. 1, 2014, now pending; and
2) U.S. patent application Ser. No. 14/580,684 filed on Dec. 23, 2014, now pending.
   All of the above-referenced applications are hereby incorporated by reference for all that they contain.

### TECHNICAL FIELD

The present disclosure relates generally to methods for generating direct communication links over the web, and more specifically to systems and methods for generating direct communication links between a publisher and a user device.

### BACKGROUND

Web-pages are information resources suitable for the World Wide Web (WWW) which can be accessed through a web browser. Web-pages typically contain content such as video content, images, RSS feeds, chats, and so on, that are intended for display and/or interaction on a user's display device.

The interaction of users with content displayed in such web-pages is usually limited by certain web-page requirements and limitations. For example, in order to respond to a chat message received on Facebook® chat, a user of a user device has to access the Facebook® website or application.

Currently, users cannot access such web-page content without specifically visiting such web-pages. However, users may wish to access such content while permitting customization of the appearance and/or functionality of the content. For example, a user may wish to alter the appearance of Facebook® chat, customize the tools (e.g., font and character selection) shown while using Facebook® chat, and/or combine content from multiple websites or applications into a single display.

Such customization would be desirable, as it would allow users to make such content more suitable for typical use by specific users. Additionally, such optimization would allow users to avoid the requirements and limitations of websites while accessing content stored thereon. Such optimization would further conserve computing resources by removing the requirement of accessing the full website or application to access content contained therein.

Additionally, the inconvenience of needing to access various web-pages to obtain access to each desired content may disincentivize users from accessing each such web-page's content. As a result, users may not access such content as frequently, thereby leading to loss of advertising revenue from users visiting web-pages or using applications containing the content.

It would therefore be advantageous to provide a solution that would overcome the deficiencies of the prior art by providing an interactive element by which users can customize the display and/or interaction with content existing over the web. It would be further advantageous if such a solution would allow users to receive additional content based on the customizations.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all embodiments. Its sole purpose is to present some concepts of one or more embodiments in a simplified form as a prelude to the more detailed description that is presented later. For convenience, the term “some embodiments” may be used herein to refer to a single embodiment or multiple embodiments of the disclosure.

Certain embodiments disclosed herein include a method for generating a direct communication link between a publisher and a user device. The method comprises receiving, from a user device, a request to generate at least one entity-based widget on a display of the user device, wherein the request comprises a selection of an entity; finding a contextual content related to the entity through at least one web source operated by at least one publisher server; determining a type of the entity based on the contextual content; generating the at least one entity-based widget based on the contextual content and the type; receiving at least one content item from the at least one publisher server; adapting a display segment within the at least one widget based on the at least one received content item; and displaying the adapted display segment on the user device.

Certain embodiments disclosed herein also include a system for generating a direct communication link between a publisher and a user device. The system comprises a processor; a widget generator; and a memory, the memory containing instructions that, when executed by the processor, configure the system to: receive, from a user device, a request to generate at least one entity-based widget on a display of the user device, wherein the request comprises a selection of an entity; find a contextual content related to the entity through at least one web source operated by at least one publisher server; determine a type of the entity based on the contextual content; generate the at least one entity-based widget based on the contextual content and the type; receive at least one content item from the at least one publisher server; adapt a display segment within the at least one widget based on the at least one received content item; and display the adapted display segment on the user device

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a schematic diagram of the operation of the system in accordance with one embodiment;

FIG. 2 is a schematic diagram of an agent for generation of entity based widgets in accordance with one embodiment;

FIG. 3 is a flowchart describing the operation of a method for generation of entity based widgets according to an embodiment; and

FIG. 4 is a flowchart describing the operation of a method for generation of a direct communication link between an entity and a user device according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments include a method and system for direct communication between a publisher server and a user device. A selection of a certain entity from a user device is received. The entity may be, for example, a person, a company, a group of people, and so on. The type of the entity selected by the user device is determined. A publisher server is enabled to communicate directly with the user device by sending the user device content items respective of an entity type of the entity. A publisher may be any type of content delivering entity that is interested in increasing user's engagement, for example, a social web administrator, an e-commerce manager, a brand manager, etc. The content items are then displayed on the user device.

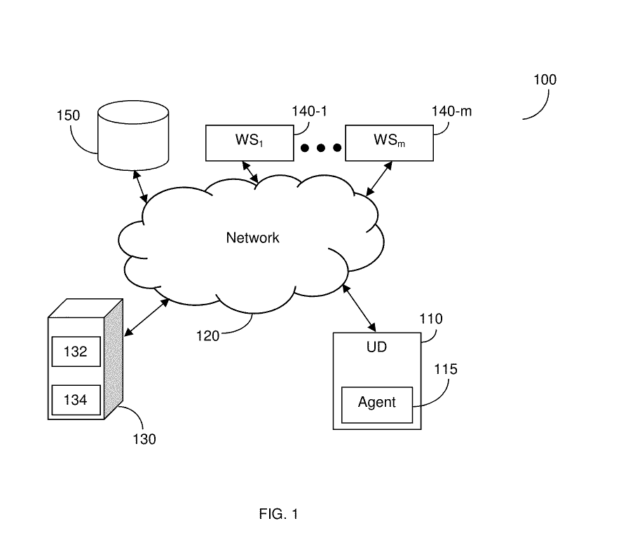

FIG. 1 shows an exemplary and non-limiting schematic diagram of a network system 100 utilized to describe the various disclosed embodiments. A user device 110 is connected to a network 120. The user device 110 may be a smart phone, a mobile phone, a laptop, a tablet computer, a wearable computing device, a personal computer (PC), a smart television and the like. The network 120 may be a local area network (LAN), a wide area network (WAN), a metro area network (MAN), the Internet, the worldwide web (WWW), a wireless network, a wired network, a cellular network, the like, and any combinations thereof.

In accordance with one embodiment, a server 130, which is also connected to the network 120, is configured to generate one or more entity-based widgets based on content existing over the network 120. The server typically comprises a processing unit 132 that is coupled to a memory 134. The memory 134 contains instructions that can be executed by the processing unit 132. According to another embodiment, the entity-based widgets may be generated based on the content existing on the user device 110. The content is extracted by the server 130 from one or more web sources 140-1 through 140-M (hereinafter referred to collectively as web sources 140 or individually as a web source 140). The web sources 140 may be, but are not limited to, web-pages, applications, and so on.

The server 130 is configured to receive a selection of an entity from the user device 110. The entity is an “object” in the world that can be defined with known types and attributes. Entities may be, but are not limited to, people, products, locations, companies, groups of people, popular keywords, applications, zip codes, and query components. The selection of the entity may be received as a query from the user device 110.

According to another embodiment, the selection may be received as a user gesture over certain content related to the selected entity via the user device 110. In that embodiment, responsive to the user gesture, the server 130 is configured to search for contextual content related to the entity through the one or more web sources 140. Contextual content that is related to an entity may be, but is not limited to, content associated with metadata representing the entity, content that is frequently provided in the same context as an entity, and so on.

Specific examples of contextual content may include, but are not limited to, contacts lists, newsfeeds, photograph albums, video playlists, music playlists, web-page content, articles, reviews of web-pages or applications, phone numbers, and so on. As a non-limiting example, contextual content that is related to the person “Paul McCartney” may include metadata associated with songs written or performed by Paul McCartney, metadata associated with videos or pictures of Paul McCartney, content related to the Beatles music group, and so on.

In another embodiment, together with the selection of an entity, the server 130 further receives from the user device 110 a selection of one or more web sources of the web sources 140 from which to collect contextual content. In an embodiment, a user may specify a source of contextual content items via, e.g., a user query. As an example, a query received from a user device 110 may include “Madonna” as the entity and “Twitter®” as the web source from which to collect contextual content related to Madonna. In that example, contextual content from Madonna's Twitter® feed or contextual content associated with tweets that mention Madonna by name may be collected from Twitter®.

In another embodiment, the source of contextual content items may be determined based on one or more preferred contextual content items of the user. In such an embodiment, the preferred contextual content items may be determined without explicitly being specified by the user. Identifying preferred contextual content items from applications without user selection is further described in the above-referenced U.S. patent application Ser. No. 14/556,672 filed on Dec. 1, 2014, the contents of which are hereby incorporated by reference.

Based on the collected contextual content, the server 130 is configured to determine the entity's type. An entity's type is a classification of an entity into one or more categories. An entity's type may designate a category of the entity. A category of an entity is describes basic aspects of the entity, such as whether the entity is a person, a group, a company, a fictional character, an animal, and so on. An entity's type may further designate one or more attributes of the entity. Attributes of the entity describe further aspects of the entity which differentiate the entity from other entities of the same category including, but not limited to, a person's job, genres of music played by a musician or band, goods or services provided by a company, the features and/or services of an application, a geographic region in which the entity lives and/or operates, and so on. As non-limiting examples, entity types may be “company,” “artist,” “actor,” “band,” “05430” (zip code), “California,” “United States,” and so on.

For the determination, the server 130 may be preconfigured with a set of rules stored in a database 150. A rule is one or more conditions for determining that an entity is a particular type. A rule may be, for example, that an entity is determined to be an artist upon identification of a number of mentions of the entity's name alongside the word “art” above a certain threshold. As another example of a rule for artists, a rule may be that an entity is determined to be an artist upon identification of a number of mentions of the entity's name alongside one or more art-related words above a certain threshold. Related words may be defined in the database 150. As an example, art-related words may include, but are not limited to, “art,” “artist,” “painting,” “drawing,” “sculpture,” and so on.

A rule related to an attribute of the entity may also require that the entity belong to at least one particular category. As a non-limiting example, a rule related to whether an entity is an artist may further require that the entity be first categorized as a person or group of people. Thus, in that example, content that would otherwise tend to indicate that an entity may be an artist will not lead to the conclusion that the entity is an artist if the entity is a company.

According to another embodiment, the type classification of one or more entities may be stored in the database 150. For example, a database may include information indicating that Michael Jackson is classified as a musician, that Microsoft® is classified as a company, that Batman® is classified as a super hero, that Paul McCartney is classified as an entertainer, and so on. According to yet another embodiment, the type of the entity may be received from the user device 110 together with the selection of the entity.

Respective of the entity type and the contextual content collected, the server 130 is configured to generate a widget. A widget is a stand-alone application with limited functionality that can be installed and executed on the user device 110 or within a web page accessed by the user device 110. The widget may be overlaid over an already existing content. The widgets may comprise links to content existing over the network 120 related to the applications. According to another embodiment, the widget may include one or more portions of applications existing over the web or alternatively installed on the user device 110. The generation of widgets based on applications is further described in the above-referenced U.S. patent application Ser. No. 14/556,672 filed on Dec. 1, 2014, the contents of which are hereby incorporated by reference.

It should be noted that different widgets may be generated respective of different types of entities. Such generation is typically performed based on what kinds of widgets will best serve inquiries related to the type of entity based on the general and/or specific attributes of the entity. Types of widgets that may best serve inquiries related to an entity with the general attribute “company” may include, but are not limited to, links to a corporate website, links to news reports about the company, a link to a social media account of the company or one or more of its employees, links to company videos, a link to an informative page related to the company (e.g., a Wikipedia® page), and so on. Types of widgets that may best serve inquiries related to an entity with the general attribute “person” may include, for example, a link to the person's social media account, links to websites owned or operated by the person, links to websites about the person, contact information of the person, a link to an informative page related to the person (e.g., a Wikipedia® page), and so on.

The types of widgets that may best serve inquiries related to an entity may be further based on more specific attributes of the entity. As an example, a widget generated for the person Justin Bieber with specific entity type “entertainer” may contain his clips or links thereto, information about upcoming concerts, and so on, while a widget generated for the company Apple® Computers with specific entity type “computer merchant” may include links to news about Apple® Computers devices, frequently asked questions and answers, ways to contact Apple® Computers' customer service center, and so on.

In an embodiment, the memory 134 containing instructions to be executed by the processing unit 132. The processing unit 132 may comprise, or be a component of, a larger processing unit implemented with one or more processors. The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing unit 132 may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing unit, cause the processing unit to perform the various functions described herein.

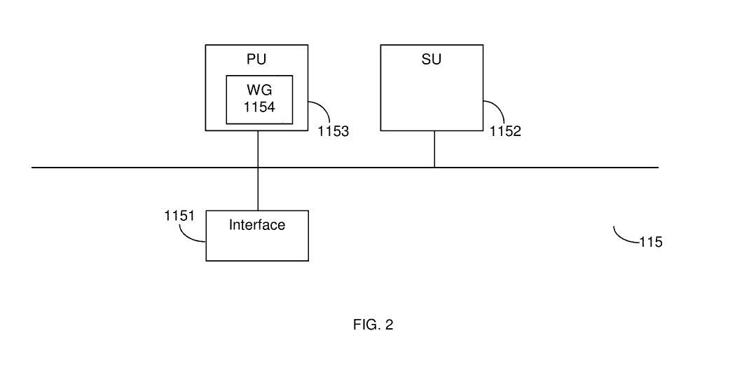

FIG. 2 depicts an exemplary and non-limiting schematic diagram of the agent 115 installed on the user device 110 according to an embodiment. The agent 115 comprises an interface 1151 through which the agent 115 receives a selection of at least one entity from the user of the user device 110. The selection of the entity may be received as a query or as a gesture over certain content related to the selected entity. Respective of the selection, a searching unit (SU) 1152 is configured to search for contextual content related to the selected entity. The selection may be performed offline respective of content existing on the user device 110 that is accessible via the network 120 through one or more of the web sources 140. The agent 115 further comprises a processing unit (PU) 1153. In an embodiment, the processing unit 1153 further comprises a widget generator (WG) 1154. The processing unit 1153 is configured to determine the entity's type based on the collected contextual content. Respective of the entity type and the contextual content collected, the processing unit 1153 is configured to generate a widget via the widget generator 1154 as further described hereinabove with respect to FIG. 1. The various units of the agent 115 can be implemented in hardware, software, microcode, firmware or any combination thereof.

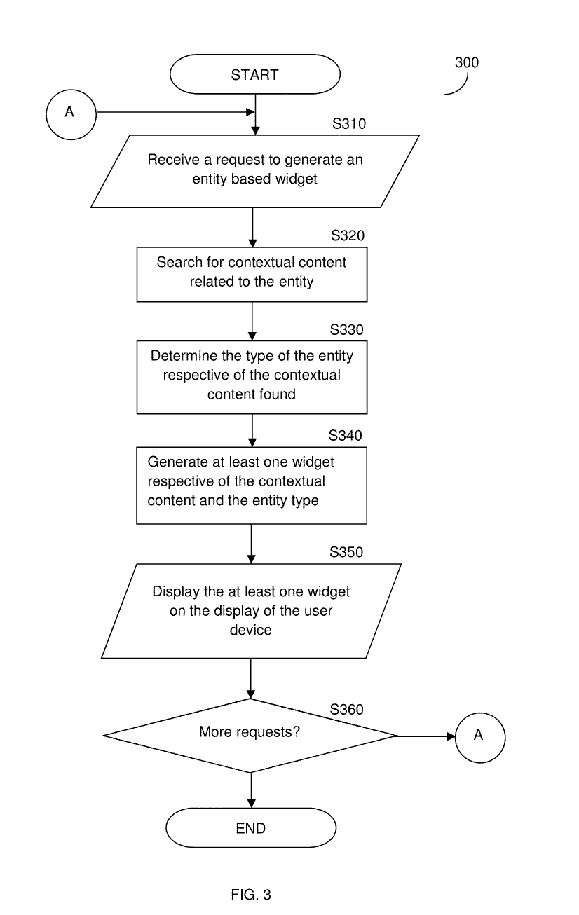

FIG. 3 depicts an exemplary and non-limiting flowchart 300 of a method for generating entity-based widgets according to an embodiment. In S310, a request to generate an entity based widget is received from a user device such as, for example, the user device 110. The request may be received as a query or as a user's gesture over the display of the user device as further described hereinabove. In S320, a search for contextual content related to the entity is performed through one or more web sources (e.g., the web sources 140). S320 may further include searching through a database (e.g., the database 150) that includes information related to certain types of entities. According to one embodiment, a selection of web sources in which to search for contextual content may be received as an input from the user device as further described hereinabove.

In S330, a type of entity is determined based on the contextual content found during the search. S330 may further include an analysis of the query received from the user device 110. As an example, the query “Microsoft Inc.” is received from the user device 110. Based on the existence of the term “Inc.,” the entity is classified as a company. Further, as contextual content related to the term “Microsoft Inc. appeared in The NASDAQ Stock Market, the company is determined as publically traded on NASDAQ.

In S340, at least one widget is generated respective of the type of the entity and the contextual content found. Different types of entities may have different types of widgets generated respective thereto. The widget may be extracted from the database. The at least one widget is generated or extracted based at least on the type of the entity. Generation of widgets respective of entity types is described further herein above with respect to FIG. 1. In S350, the generated widget is sent for display on the display of the user device. In S360, it is checked whether there are additional requests and if so, execution continues with S310; otherwise, execution terminates.

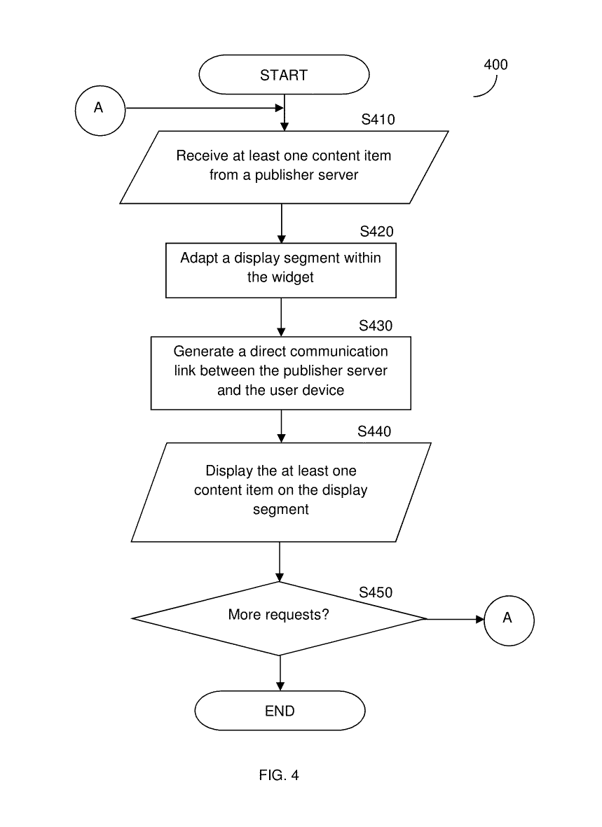

FIG. 4 depicts an exemplary and non-limiting flowchart 400 of a method for generating a direct communication link between a publisher server operating an entity and a user device (e.g., the user device 110) according to an embodiment. In S410 at least one content item is received from a publisher server operating the entity. In S420, respective of the at least one content item received, a display segment within the display of the user device is adapted by a server (e.g., the server 130). In S430, a direct communication link is generated between the publisher server and the user device. In S440, the content item is displayed on the display segment. In S450, it is checked whether there are additional requests and, if so, execution continues with S410; otherwise, execution terminates.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for generating a direct communication link between a publisher and a user device, comprising:
receiving, from a user device, a request to generate at least one entity-based widget on a display of the user device, wherein the request comprises a selection of an entity;
finding a contextual content related to the entity through at least one web source operated by at least one publisher server;
determining a type of the entity based on the contextual content;
generating the at least one entity-based widget based on the contextual content and the type;
receiving at least one content item from the at least one publisher server;
adapting a display segment within the at least one widget based on the at least one received content item; and
displaying the adapted display segment on the user device.

2. The method of claim 1, wherein the type of the contextual content is at least one of: a category, and an attribute.

3. The method of claim 1, wherein the selection of the entity is at least one of: a query, and a user gesture.

4. The method of claim 1, wherein the request further comprises a selection of at least one web source.

5. The method of claim 1, further comprising:
determining the at least one web source through which to find the contextual content based on at least one preferred contextual content item.

6. The method of claim 1, wherein determining the type of the entity is based on at least one rule of a plurality of rules.

7. The method of claim 6, wherein the at least one rule indicates a required category.

8. The method of claim 1, wherein determining the type of the entity further comprises:
retrieving a type classification of the at least one entity from a database.

9. The method of claim 1, wherein the at least one entity-based widget is generated based on any one of: the type of the at least one entity, and the contextual content.

10. A non-transitory computer readable medium having stored thereon instructions for causing one or more processing units to execute the method according to claim 1.

11. A system for generating a direct communication link between a publisher and a user device, comprising:
a processor;
a widget generator; and
a memory, the memory containing instructions that, when executed by the processor, configure the system to:
receive a request to generate at least one entity-based widget on a display of the user device, wherein the request comprises a selection of an entity;
find a contextual content related to the entity through at least one web source operated by at least one publisher server;
determine a type of the entity based on the contextual content;
generate the at least one entity-based widget based on the contextual content and the type;
receive at least one content item from the at least one publisher server;
adapt a display segment within the at least one widget based on the at least one received content item; and
display the adapted display segment on the user device.

12. The system of claim 11, wherein the type of the contextual content is at least one of: a category, and an attribute.

13. The system of claim 11, wherein the selection of the entity is at least one of: a query, and a user gesture.

14. The system of claim 11, wherein the request further comprises a selection of at least one web source.

15. The system of claim 11, wherein the system is further configured to:
determine the at least one web source through which to find the contextual content based on at least one preferred contextual content item.

16. The system of claim 11, wherein determining the type of the entity is based on at least one rule of a plurality of rules.

17. The system of claim 16, wherein the at least one rule indicates a required category.

18. The system of claim 11, wherein the system is further configured to:
retrieve a type classification of the at least one entity from a database.

19. The system of claim 1, wherein the at least one entity-based widget is generated based on any one of: the type of the at least one entity, and the contextual content.
